(19) United States
(12) Patent Application Publication
(10) Pub. No.: US 2005/0279201 A1
(43) Pub. Date: Dec. 22, 2005

(54) Corner cutter device

(76) Inventor: Chun Yuan Chang, Taichung (TW)

Correspondence Address: Chun Yuan Chang, P.O. Box 63-99, Taichung, 406, TW

(21) Appl. No.: 10/872,210

(22) Filed: Jun. 16, 2004

(51) Int. Cl. B26D 5/08

(52) U.S. Cl. 83/589; 83/467.1; 83/564

(57) ABSTRACT

A corner cutter device includes a receptacle having a chamber formed by an outer peripheral wall, and a platform extended from the receptacle to form a front corner area. An anvil plate is disposed on the front corner area of the platform, the receptacle includes two seats, a cover is attached to enclose the chamber of the receptacle, a casing is slidably received in the receptacle and has an arm pivotally attached to the receptacle, a cutter blade is attached to the casing and movable toward the anvil plate to conduct paper cutting operations. A spring member may bias the cutter blade away from the anvil plate after the casing is released or after the cutting operations.

### BACKGROUND OF THE INVENTION

1. Field of the Invention

The present invention relates to a corner cutter device, and more particularly to a corner cutter device having a receptacle to receive and store cut paper chips or the like.

2. Description of the Prior Art

Typical corner cutter devices have been developed for cutting corner areas of paper sheets, cards, or the like, and comprise a movable cutter blade attached to a handle, and movable toward or away from a stationary cutter blade, for conducting the paper cutting operations.

For example, U.S. Pat. No. 6,016,733 to Lin discloses one of the typical corner cutter devices comprising a body including a stationary cutter blade attached thereto, and a handle pivotally attached to a corner area of the body and including a movable cutter blade attached thereto, and movable toward or away from the stationary cutter blade, for cutting corner areas of paper sheets or the like.

However, the stationary cutter blade and the movable cutter blade are both exposed, such that the typical corner cutter devices have no space or receptacle to receive the cut paper chips or the like that are cut from the paper sheets or cards, such that the users have to clean the cut paper chips after every cutting operation.

The present invention has arisen to mitigate and/or obviate the afore-described disadvantages of the conventional corner cutter devices.

### SUMMARY OF THE INVENTION

The primary objective of the present invention is to provide a corner cutter device including a receptacle to receive and store cut paper chips or the like.

In accordance with one aspect of the invention, there is provided a corner cutter device comprising a receptacle including a chamber formed therein and defined by an outer peripheral wall, and a platform extended from an upper and rear portion of the receptacle, to form a front corner area in the platform, and to form an open space in a front portion of the receptacle and communicating with the chamber of the receptacle, the receptacle including a pair of protuberances extended upwardly from two sides of the rear portion thereof, for guiding paper sheets toward the front corner area of the platform, an anvil plate disposed on the front corner area of the platform, the receptacle including two seats extended into the chamber thereof, and each having an orifice formed therein, a cover attached to bottom of the receptacle to enclose the chamber of the receptacle, a casing slidably received in the open space of the receptacle, and movable up and down relative to the platform, and including an arm extended therefrom, and a shaft extended from the arm and rotatably engaged in the orifices of the seats, to pivotally attach the casing to the receptacle, a cutter blade attached to the casing, and located above the anvil plate, and movable toward the anvil plate to conduct paper cutting operations, and a spring member engaged between the casing and the cover, for biasing the casing upwardly relative to the platform, and for biasing the cutter blade away from the anvil plate after the casing is released.

The cover includes a peripheral rib extended upwardly therefrom, to engage into the chamber of the receptacle, and to engage with the outer peripheral wall, for detachably securing the cover to the receptacle.

The cover includes a hub extended therefrom to receive an end portion of the spring member. The casing may also include a hub extended therefrom to receive an end portion of the spring member. The seats may be extended from the outer peripheral wall of the receptacle, and/or may be extended from the platform.

A second spring member may further be provided and coupled between the arm of the casing and the receptacle, to resiliently couple the casing to the receptacle. A first seat of the seats includes a pin extended therefrom for coupling to the second spring member. The arm of the casing includes a pin extended therefrom for coupling to the second spring member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a corner cutter device in accordance with the present invention;

FIG. 2 is a perspective view of the corner cutter device;

FIG. 3 is a cross sectional view taken along lines 3-3 of FIG. 2; and

FIG. 4 is a cross sectional view of the corner cutter device, similar to FIG. 3, illustrating the operation of the corner cutter device.

### DETAILED DESCRIPTION OF THE PREFERRED EMBODIMENT

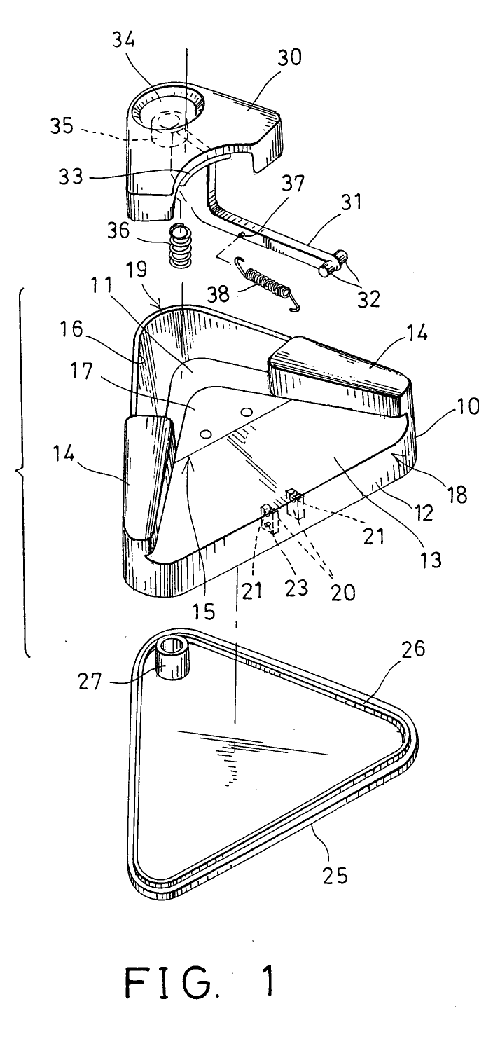

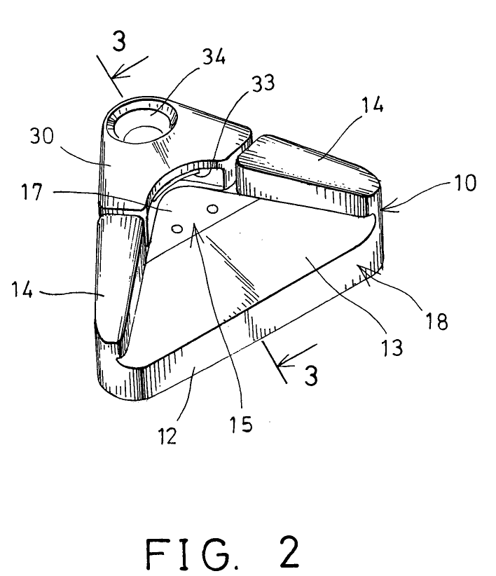

Referring to the drawings, and initially to FIGS. 1-3, a corner cutter device in accordance with the present invention comprises a receptacle 10 including a chamber 11 formed therein and defined by an outer peripheral wall 12, and a platform 13 extended from an upper and rear portion 18 thereof toward intermediate portion thereof.

The platform 13 does not fully extended across the receptacle 10, or does not fully extended through or toward the front portion 19 of the receptacle 10, so as to form a free front corner area 15 in the platform 13, and in order to form an open space 16 in the front portion 19 of the receptacle 10, and communicating with the chamber 11 of the receptacle 10.

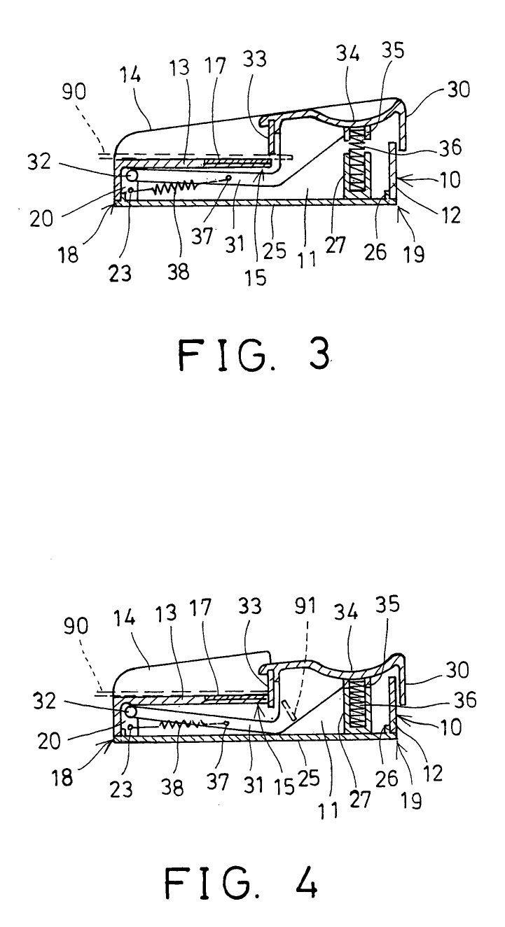

The receptacle 10 includes a pair of protuberances 14 extended upwardly from the two sides of the rear portion 18 thereof, to engage with and to guide paper sheets 90 (FIGS. 3-4) toward the front corner area 15 of the platform 13. A stationary cutter blade or an anvil plate 17 is disposed or secured on the front corner area 15 of the platform 13, and preferably flush with the platform 13, best shown in FIGS. 3, 4.

The receptacle 10 includes one or more, such as two seats 20 extended into the chamber 11 thereof from the outer peripheral wall 12 and/or from the platform 13, and each of the seats 20 includes an orifice 21 formed therein. One of the seats 20 includes a pin 23 extended therefrom.

A cover 25 is attached to the bottom of the receptacle 10 to enclose the chamber 11 of the receptacle 10, and includes a peripheral rib 26 extended upwardly therefrom, to engage into the chamber 11 of the receptacle 10, and to engage with the outer peripheral wall 12, for detachably securing the cover 25 to the receptacle 10 with such as a force-fitted engagement. The cover 25 includes a hub 27 extended therefrom.

A casing 30 is slidably received in the open space 16 of the receptacle 10, and movable up and down relative to the platform 13, and includes an arm 31 extended therefrom, and a shaft 32 extended from the arm 31 and rotatably engaged in the orifices 21 of the seats 20, to pivotally or rotatably attach the casing 30 to the receptacle 10.

The casing 30 includes a cutter blade 33 attached thereto, and located above the anvil plate 17 of the platform 13 or of the receptacle 10, for moving toward the anvil plate 17 to conduct the paper cutting operations, best shown in FIGS. 3, 4. The casing 30 includes a depression 34 formed thereon, for allowing the users to easily depress the casing 30 downwardly relative to the platform 13, in order to conduct the paper cutting operations.

The casing 30 includes a hub 35 extended downwardly therefrom, and a spring member 36 has end portions received in the hub 35 of the casing 30 and the hub 27 of the cover 25, for biasing the casing 30 upwardly relative to the platform 13, or for biasing the cutter blade 33 away from the anvil plate 17 of the platform 13 or of the receptacle 10. The arm 31 of the casing 30 may further include a pin 37 extended therefrom, and another spring member 38 has two ends attached to the pins 37, 23 of the arm 31 and the seat 20, to further resiliently couple the arm 31 to the receptacle 10.

In operation, as shown in FIGS. 3 and 4, the casing 30 may be depressed downwardly against the spring member 36, to force the cutter blade 33 away from the anvil plate 17 of the platform 13 or of the receptacle 10, in order to conduct the paper cutting operations. The spring member 36 and/or the spring member 38 may bias the casing 30 upwardly away from the platform 13 after the cutting operations. The cut paper chip 91 from the paper sheets 90 may be received and stored in the chamber 11 of the receptacle 10.

Accordingly, the corner cutter device in accordance with the present invention includes a receptacle to receive and store cut paper chips or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A corner cutter device comprising:
a receptacle including a chamber formed therein and defined by an outer peripheral wall, and a platform extended from an upper and rear portion of said receptacle, to form a front corner area in said platform, and to form an open space in a front portion of said receptacle and communicating with said chamber of said receptacle,
said receptacle including a pair of protuberances extended upwardly from two sides of said rear portion thereof, for guiding paper sheets toward said front corner area of said platform,
an anvil plate disposed on said front corner area of said platform,
said receptacle including two seats extended into said chamber thereof, and each having an orifice formed therein,
a cover attached to bottom of said receptacle to enclose said chamber of said receptacle,
a casing slidably received in said open space of said receptacle, and movable up and down relative to said platform, and including an arm extended therefrom, and a shaft extended from said arm and rotatably engaged in said orifices of said seats, to pivotally attach said casing to said receptacle,
a cutter blade attached to said casing, and located above said anvil plate, and movable toward said anvil plate to conduct paper cutting operations, and
a spring member engaged between said casing and said cover, for biasing said casing upwardly relative to said platform, and for biasing said cutter blade away from said anvil plate after said casing is released.

2. The corner cutter device as claimed in claim 1, wherein said cover includes a peripheral rib extended upwardly therefrom, to engage into said chamber of said receptacle, and to engage with said outer peripheral wall, for detachably securing said cover to said receptacle.

3. The corner cutter device as claimed in claim 1, wherein said cover includes a hub extended therefrom to receive an end portion of said spring member.

4. The corner cutter device as claimed in claim 1, wherein said casing includes a hub extended therefrom to receive an end portion of said spring member.

5. The corner cutter device as claimed in claim 1, wherein said seats are extended from said outer peripheral wall of said receptacle.

6. The corner cutter device as claimed in claim 1, wherein said seats are extended from said platform.

7. The corner cutter device as claimed in claim 1 further comprising a second spring member coupled between said arm of said casing and said receptacle, to resiliently couple said casing to said receptacle.

8. The corner cutter device as claimed in claim 7, wherein a first seat of said seats includes a pin extended therefrom for coupling to said second spring member.

9. The corner cutter device as claimed in claim 7, wherein said arm of said casing includes a pin extended therefrom for coupling to said second spring member.
